(19) United States
(12) Patent Application Publication
(10) Pub. No.: US 2014/0243080 A1
(43) Pub. Date: Aug. 28, 2014

(54) GAMING SYSTEM AND METHOD

(71) Applicant: Aristocrat Technologies Australia Pty Limited, North Ryde (AU)

(72) Inventor: Petter Lindborg, Vendelso (CH)

(73) Assignee: Aristocrat Technologies Australia Pty Limited, North Ryde (AU)

(21) Appl. No.: 14/191,972

(22) Filed: Feb. 27, 2014

(30) Foreign Application Priority Data
Feb. 28, 2013 (AU) 2013900681

(51) Int. Cl. G07F 17/32

(52) U.S. Cl. CPC G07F 17/3241
USPC 463/29

(57) ABSTRACT

A method of authorizing access to a gaming system component. The method includes receiving a request for access to a gaming system component using an identification device. In response to the access request, the gaming system component generates and outputs an access control code based on a gaming system component identifier and an identifier of the identification device. The method also includes receiving the access control code at a computer implemented access controller whereafter the access controller, identifies from the access control code the gaming system component subject of the access request and the operator making the request based on the identification device identifier, and determines access permission based on a combination of the gaming system component and an access level assigned to the operator, upon access being permitted, generating an access return code, and receiving the access return code at the gaming system component to enable operator access.

### RELATED APPLICATIONS

This application claims priority to Australia Provisional Application No. 2013900681 having a filing date of Feb. 28, 2013, which is incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

It is important to maintain the security of gaming machines in both networked and stand alone configurations to ensure integrity of the gaming machines is maintained and avoid unauthorized or malicious access. Casino personnel require access to gaming machines for operation and maintenance typically personnel carry multiple keys to enable them to unlock the gaming machines when access is required. Use of physical keys requires the keys to the controlled. It can also be cumbersome for personnel to carry the keys and locate the appropriate key for a gaming machine when access is required. Further, a key may be used to access a gaming machine in an unauthorized manner for example, if a key is lost or used inappropriately.

There is a need for improved access control.

### BRIEF SUMMARY OF THE INVENTION

In a first aspect, the invention provides a method of authorizing access to a gaming system component, the method comprising the steps of:
receiving a request from an operator for access to a gaming system component using an identification device;
in response to the access request, the gaming system component generating and outputting an access control code, the access control code being generated based on a gaming system component identifier and an identifier of the identification device;
receiving the access control code at a computer implemented access controller whereafter the access controller, identifies from the access control code the gaming system component subject of the access request and the operator making the request based on the identification device identifier, and determines access permission based on a combination of the gaming system component and an access level assigned to the operator; and
upon access being permitted, generating an access return code; and
receiving the access return code at the gaming system component to enable operator access.

The access return code can include login validation data and operator specific access permission data. The operator specific access permission data can be encrypted.

In an embodiment the access control code and the access return code are communicated via a gaming network.

In another embodiment the access control code and access return code are communicated via the operator's identification device.

Access to the gaming system component can be determined by the central controller looking up specific access permissions for the operator identified by their identifier device identifier and determining access permissions for the gaming system component subject of the access request.

In an embodiment the gaming system component identifier is a secret key. The secret key of each gaming system component can be stored in a database of the access controller.

An embodiment of the method further comprises the step of configuring operator access permissions for one or more gaming system component by updating stored access permission data of the access controller only.

The method can be used to access networked or stand alone gaming system components.

The method can further comprise the step of providing data to the gaming system component after access is granted.

In a second aspect, the invention provides a gaming system comprising:
one or more gaming system components, each gaming system component including an access control module adapted to, in response to an access request made using an identification device, generate an access control code based on a gaming system component identifier and an identifier of the identification device, and allow access to the gaming system component in response to receiving an authorizing access return code;
an access controller adapted to receive the access control code and determine access permission based on a combination of the gaming system component and access level assigned to the operator of the identification device, and where access is to be permitted generate an access return code to enable the operator to access the requested gaming system component.

The access controller can include a database storing access permission data and access to the gaming system component is determined by the access controller looking up specific access permissions for the operator identified by their identifier device identifier and determining access permissions for the gaming system component subject of the access request.

Operator access permissions can be configured for one or more gaming system component by updating stored access permission data of the access controller database only.

In a third aspect, the invention provides a gaming system access controller comprising:
a database storing access permission data;
a communication interface adapted to receive access control codes and transmit access return codes; and
a control module adapted to, in response to receiving an access control code, generated by a gaming system component based on a identifier of an identification device used to request access to the gaming system component and an identifier of the gaming system component, looking up stored access permission data in the database to determine access permission based on a combination of the gaming system component and access level assigned for the operator of the identification device, and generating an access return code including login validation data and specific access permission data for access to the gaming system component.

In a fourth aspect, the invention provides a gaming system component including an access control module adapted to, in response to an access request made using an identification device, generate an access control code based on a gaming system component identifier and an identifier of the identification device for transmission to an access controller, and in response to receiving an authorizing access return code generated by the access controller allow operator access to the gaming system component.

In a fifth aspect, the invention provides computer program code which when executed implements the above method.

In a sixth aspect, the invention provides a tangible computer readable medium comprising the above program code.

In a seventh aspect, the invention provides a data signal comprising the above program code.

### BRIEF DESCRIPTION OF SEVERAL VIEWS OF THE DRAWINGS

An exemplary embodiment of the invention will now be described with reference to the accompanying drawings in which:

FIG. 1 is a block diagram of the core components of a gaming system;

FIG. 2 is a perspective view of a stand alone gaming machine;

FIG. 3 is a block diagram of the functional components of a gaming machine;

FIG. 4 is a schematic diagram of the functional components of a memory;

FIG. 5 is a schematic diagram of a network gaming system;

FIG. 6 is a further block diagram of a gaming system; and

FIG. 7 is a flow chart of an embodiment.

### DETAILED DESCRIPTION OF THE INVENTION

Referring to the drawings, there is shown a gaming system having a game controller arranged to implement a game and an access controller enabling access to components of the gaming system to be centrally configured and controlled. The gaming system components for which access can be controlled can include stand alone or networked gaming machines, game controllers, bonus controllers and gaming network components.

### General Construction of Gaming System

The gaming system can take a number of different forms. In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

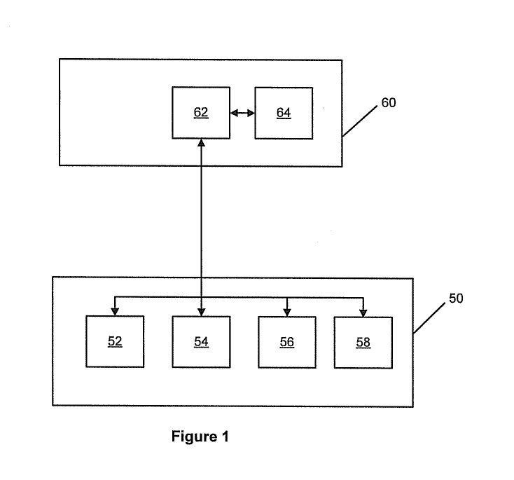

Irrespective of the form, the gaming system has several core components. At the broadest level, the core components are a player interface 50 and a game controller 60 as illustrated in FIG. 1. The player interface is arranged to enable manual interaction between a player and the gaming system and for this purpose includes the input/output components required for the player to enter instructions to play the game and observe the game outcomes.

Components of the player interface may vary from embodiment to embodiment but will typically include a credit mechanism 52 to enable a player to input credits and receive payouts, one or more displays 54, a game play mechanism 56 including one or more input devices that enable a player to input game play instructions (e.g. to place a wager), and one or more speakers 58.

The game controller 60 is in data communication with the player interface and typically includes a processor 62 that processes the game play instructions in accordance with game play rules and outputs game play outcomes to the display. Typically, the game play rules are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server. That is a processor may be provided by any suitable logic circuitry for receiving inputs, processing them in accordance with instructions stored in memory and generating outputs (for example on the display). Such processors are sometimes also referred to as central processing units (CPUs). Most processors are general purpose units, however, it is also know to provide a specific purpose processor using an application specific integrated circuit (ASIC) or a field programmable gate array (FPGA).

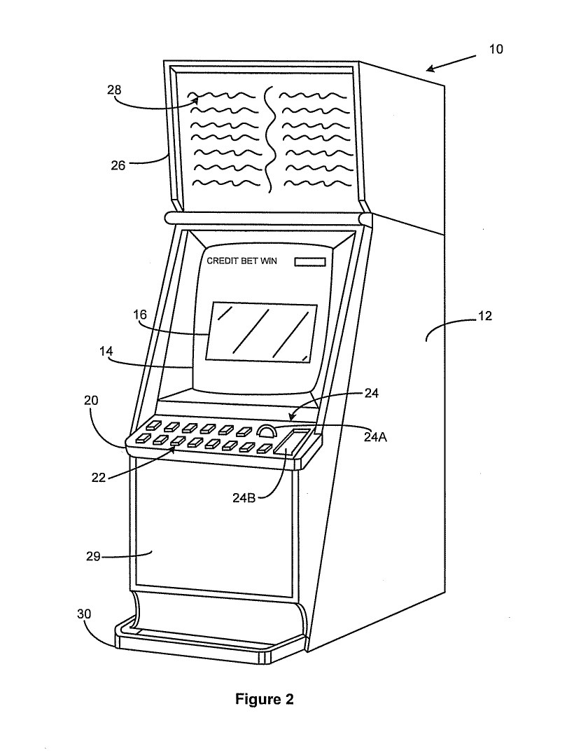

A gaming system in the form of a stand alone gaming machine 10 is illustrated in FIG. 2. The gaming machine 10 includes a console 12 having a display 14 on which are displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. Other gaming machines may configure for ticket in such that they have a ticket reader for reading tickets having a value and crediting the player based on the face value of the ticker. A player marketing module (not shown) having a reading device may also be provided for the purpose of reading a player tracking device, for example as part of a loyalty program. The player tracking device may be in the form of a card, flash drive or any other portable storage medium capable of being read by the reading device. In some embodiments, the player marketing module may provide an additional credit mechanism, either by transferring credits to the gaming machine from credits stored on the player tracking device or by transferring credits from a player account in data communication with the player marketing module.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

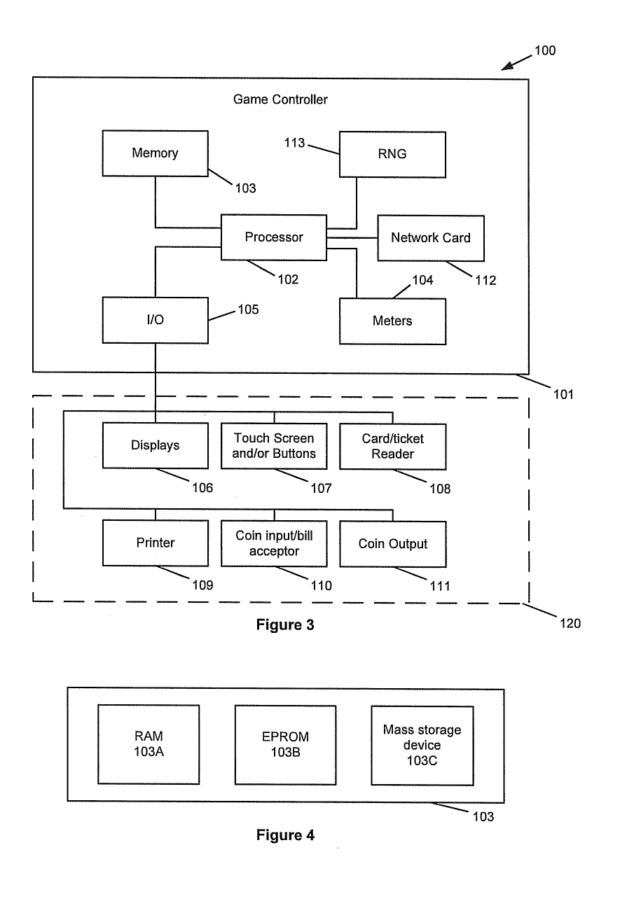

FIG. 3 shows a block diagram of operative components of a typical gaming machine which may be the same as or different to the gaming machine of FIG. 2.

The gaming machine 100 includes a game controller 101 having a processor 102 mounted on a circuit board. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 including one or more displays 106, a touch screen and/or buttons 107 (which provide a game play mechanism), a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation. For example, while buttons or touch screens are typically used in gaming machines to allow a player to place a wager and initiate a play of a game any input device that enables the player to input game play instructions may be used. For example, in some gaming machines a mechanical handle is used to initiate a play of the game. Persons skilled in the art will also appreciate that a touch screen can be used to emulate other input devices, for example, a touch screen can display virtual buttons which a player can “press” by touching the screen where they are displayed.

In addition, the gaming machine 100 may include a communications interface, for example a network card 112. The network card may, for example, send status information, accounting information or other information to a bonus controller, central controller, server or database and receive data or commands from the bonus controller, central controller, server or database. In embodiments employing a player marketing module, communications over a network may be via player marketing module—i.e. the player marketing module may be in data communication with one or more of the above devices and communicate with it on behalf of the gaming machine.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

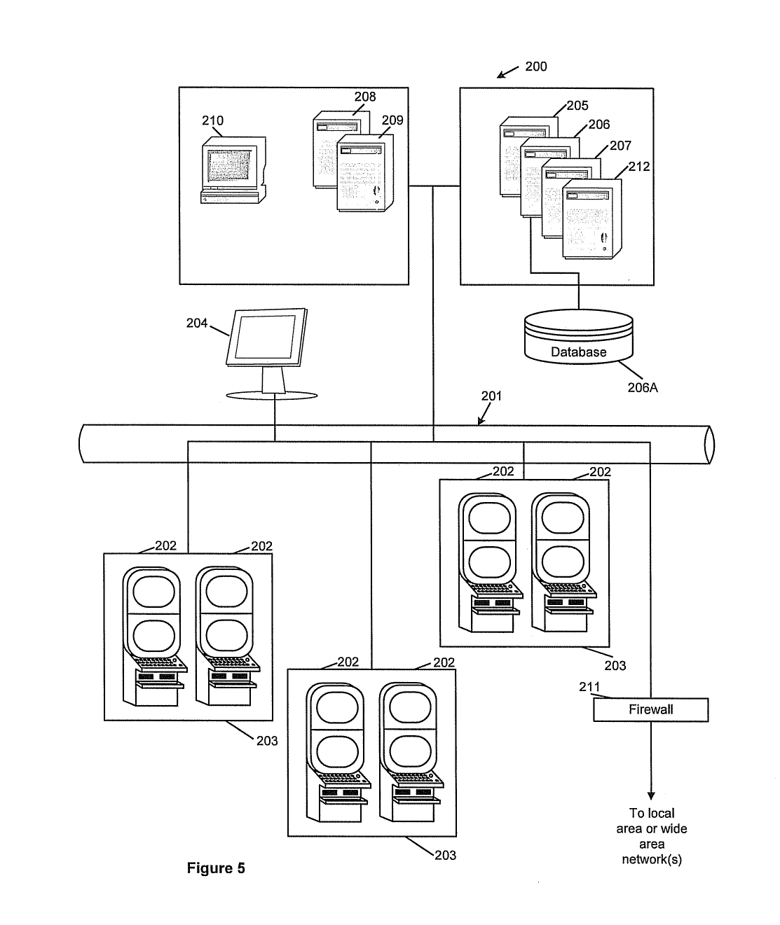

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. For example, the displays 204 may be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to perform accounting functions for the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components. Other client/server configurations are possible, and further details of a client/server architecture can be found in WO 2006/052213 and PCT/SE2006/000559, the disclosures of which are incorporated herein by reference.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming system 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of game servers could be provided to run different games or a single game server may run a plurality of different games as required by the terminals.

### Further Detail of Gaming System

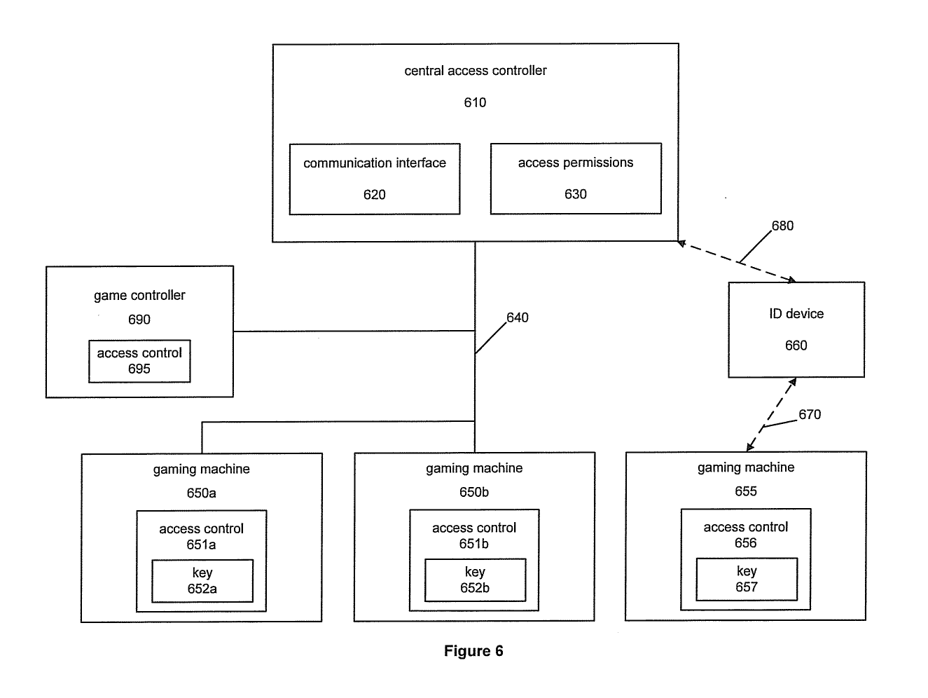

FIG. 6 shows a an example of a gaming system having a central access controller 610 and a variety of gaming system components. The gaming system components include three gaming machines, two of which 650a, 650b are networked gaming machines connected via a gaming network 640 to a game controller 690, and one gaming machine 655 that is a stand-alone gaming machine not connected to the gaming network 640. The game controller 690 is also a gaming system component. As aspects of the present invention relate to controlling access to the gaming system components, the actual game or games playable on the gaming machines will not be discussed. It should be appreciated that embodiments of the present invention are applicable to any type of gaming machines playing any style of game or games.

The central access controller 610 stores access permissions 630 for all personnel who may access the gaming system components. Access permissions for an operator may vary depending on the type of system components. For example, casino floor personnel may be permitted access to gaming machines only and denied access to gaming system components such as game controllers and gaming network equipment such as servers and hubs. In another example, an IT specialist may be permitted full access to gaming network equipment, but access to gaming system components such as game controllers and gaming machines may be limited to accessing communication interfaces, thus the IT specialist is prohibited from accessing aspects of game components relating to game play and credit handling. The central access controller 610 may also store data relating to each system component such as status or maintenance schedule which may influence whether or not access will be granted for a system component irrespective of stored operator access permissions. For example, access to a gaming machine may be denied outside of scheduled maintenance if the gaming machine status indicates normal operation. Access permissions can all be centrally controlled and configured it via the central access controller.

The central access controller 610 can also include a communication interface 620 enabling communication with the gaming system components via the gaming network 640. The communication interface 620 may also be adapted to enable external communication with the central access controller 610.

Each gaming system component can be provided with an access control module. The access control module is adapted to generate a control code in response to a request to access the gaming system component made via an identification device 660 controlled by an operator, and to enable access to the gaming system component in response to receiving and authorizing return code. The return code being generated by the central access controller 610 based on a combination of the gaming system component and access level assigned to the operator requesting access as identified by the identification device 660.

The operator identification device 660 can be any device suitable to identify the operator. For example, the identification device 660 may be a simple token or card carrying an identification code readable by gaming system components, for example an RFID chip, magnetic tape, or barcode. In another example, the identification device may be a processing device such as a mobile phone, smart phone or portable computer executing an appropriate software application, or a dedicated hardware device which stores and identification code and is adapted to communicate with the gaming system component, for example by connection to a physical port, such as a USB port, or via a wireless connection, such as Bluetooth. In another example, the identification device may be a security token device which generates identification codes which can be manually input to the gaming system component via a user interface of the gaming system component.

Each gaming system component having access controlled by the central access controller includes an access control module. In FIG. 6, the processor 62 of the game controller 60 for each gaming machine 650a, 650b, 655 implements a number of modules based on program code and data stored in memory 64. Persons skilled in the art will appreciate that various of the modules could be implemented in some other way, for example by a dedicated circuit. These modules implement aspects of game play and control functions. The only module shown in FIG. 6 is the access control module.

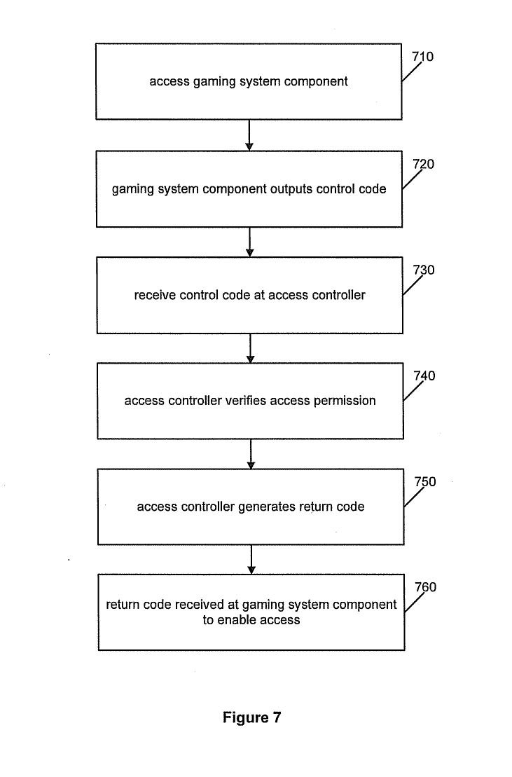

FIG. 7 is a flowchart of a method for accessing a game system component. An operator requests access to a system component using an identification device 710. In response to the access request, the gaming system component generates and outputs an access control code based on a gaming system component identifier and an identifier of the identification device 720. This access control code is provided to the access controller 730 which determines access permission based on a combination of the gaming system component identifier and the access level of the operator 740. The access controller generates an access return code 750 which is then provided to the gaming system component to enable operator access 760.

### Example 1

In a first illustrative example, we will consider accessing the gaming machine 650a by a casino floor operator in response to a fault. The casino floor operator uses their identification device 660 to request access to the gaming machine 650a, for example, by connecting the ID device 660 to the gaming machine via a USB port. The ID device 660 communicates its identifier to the access control module 651a of the gaming machine 650a. The access control module stores a secret key 652a for the gaming machine 650a. This secret key 652a is also known by the central access controller 610 and is used by the central access controller as a secure identifier for the gaming machine 650a.

The access control module 651a of the gaming machine 650a generates an access control code based on the secret key 651a and the ID device 660 identifier. The access control code may include status information, for example a binary flag indicating that the gaming machine is operating normally or experiencing a fault condition. This access control code is provided to the central access controller 610. In this example as the gaming machine 650a and central access controller are connected via the gaming network 640. Therefore the access control code may be provided to the central access controller 610 by the gaming machine 650a via the gaming network 640. The access control code may be encrypted, for example using a key for the central access controller to inhibit a gaming machine secret key from being discovered if an access control message is maliciously intercepted.

The central access controller 610 receives the access control code and from this code identifies the gaming machine 650a subject of the access request and the ID device 660 used to make the request. Using this information the central access controller can look up access permission data 630, including authorized access permissions for the operator assigned the ID device 660 and access permissions specific to the gaming machine 650a. For example, the operator may be provided with level 2 access permissions which allow access to gaming machines for routine maintenance activities or in the case of faults. The operator's access may also be limited to gaming machines of the section of the casino to which the operator is allocated for their work shift. Access permissions allocated for the gaming machine may indicate what access operators at each level may be granted, maintenance schedule information and any other information relevant to grating access. Other information, such as gaming machine status may also be taken into account. This information may be stored in a frequently updated database, provided in the access control code or provided in response to a query by the central access controller. The central access controller 610 looks up the access permissions 630 and determines, based on a combination of permissions for the gaming machine and the operator, whether or not the operator is to be granted access to the requested gaming machine 650a. The central access controller can also log the access request.

The access controller generates 610 an access return code to enable access to the gaming machine 650a. The access return code can include login verification information and specific access permissions for the login session. The specific access permissions are determined by the central access controller for the operator accessing the gaming machine. For example, if the nature of the fault is known then only access permissions sufficient to fix the fault condition may be granted. The list of specific access permissions may be encrypted.

The access return code can be provided to the gaming machine 650a via the gaming network 640. The access control module 651a of the gaming machine 650a reads the access return code and grants access in accordance with the specific permissions defined in the return code. It should be appreciated that the access to the gaming machine is controlled by the central access controller. The access control module 651a of the gaming machine 650a generates the access control code and grants access based on the access return code but performs no local verification of the operator ID for login.

Once the operator has performed the necessary actions to clear the fault, the ID device can be removed to terminate the operator access. Alternatively or additionally the access control module may terminate the access session after a set time period, for example 5 minutes, to ensure that access does not remain open. The time period may be predetermined or set for an access session based on the purpose for the access. For example, a fault fix may only require 2-5 minutes whereas routine maintenance actions may require 10-20 minutes access. The access time may be set in the access return code.

### Example 2

In another example, we will consider accessing the stand-alone gaming machine 655 for routine maintenance. The gaming machine 655 is not connected to the gaming network 640 and therefore the access control code and access return code cannot be directly transmitted between the gaming machine 655 and the central access controller 610 via the gaming network 640.

An operator requests access to the stand alone gaming machine 655 using identification device 660. In this example the ID device 660 is a computing device having communication network connectivity, for example a mobile phone, smart phone, laptop or tablet computer which can be connected to the gaming machine via an appropriate cable or wireless connection 670. In this example the access control code is generated by the access control module 656 using the gaming machine secret key 657 and the ID device 660 identifier and provided to the ID device 660 for transmission 680 to the central access controller 610 via a communication network external to the gaming network 640. In this example the access control code is encrypted for transmission if being transmitted via a public telecommunication network. Alternatively the access control code may be transmitted via a secure local network, such as WIFI or LAN, and in this case encryption may be optional.

The central access controller 610 can include a communication interface 620 for connection to a communication network which may be a local network (i.e. WIFI, Ethernet etc.) or an external communication network. The central access controller 610 receives the access control code via the communication network interface 620. The central access controller 610 decodes the access control code to identify the gaming machine subject of the access request and the operator, based on the gaming machine secret key 657 and ID device 660 identifier respectively. The central access controller 610 looks up the access permissions to determine whether or not to validate the access request. In this example, routine maintenance is scheduled for the gaming machine 655 at the time of the access request and the operator assigned to the ID device 660 is the operator authorized to perform the required maintenance. The access request is validated, logged and an access return code generated. The access return code includes login validation information and a list of specific access permissions for the maintenance to be performed.

The access return code is transmitted 680 to the ID device 660 via the communication network and input 670 to the gaming machine 655 via the ID device 660. The access control module 656 decodes the access return code and grants access based on the specific access permissions. After access has been granted, data may be transmitted to the gaming machine 655 from or via the ID device. For example, updates to game software may be stored on the ID device and transmitted to the gaming machine. Alternatively, data may be transmitted to the ID device for download to the gaming machine.

### Example 3

In another example where the stand alone gaming machine 655 is accessed, the access control code and access return codes are manually provided to the central access controller 610 and gaming machine 655 respectively. In this embodiment the ID device 660 may be an operator ID card or token including an electronically readable identifier, for example, RFID chip, magnetic tape, smart card chip etc. The operator inputs the identifier via a user interface of the gaming machine 655 initiate and access request. The access control module 656 generates an access control code based on the gaming machine identifier and the operator identifier and outputs the access control code via a user interface of the gaming machine, for example, by displaying the access control code as a 9 digit number on a display. The access control code may be encrypted. The operator manually provides the access control code to the central access controller, for example via a software application in a smart phone, laptop or tablet computer, or via a message such as an SMS message or e-mail from a mobile phone, smart phone or other communication device. The access control code may be sent via a secure local network or an external telecommunication network and is received via the communication interface 620 of the central access controller.

The central access controller 610 verifies the access request by looking up specific permissions for the operator and gaming machine 655. Where access is permitted, the central access controller generates an access return code which is transmitted back to the operator's device via the communication network. Encrypted in the access return code are login validation data and specific access permissions. As the access control code and access return code are manually handles these may be sequences of numbers and letters able to be input via a keyboard, keypad or touch screen user interface and interpreted by the central access controller and access control module respectively in accordance with access code rules stored in memory. Alternatively the access control code and access return code may be generated as bar codes, images or in any other form which may be transferred between a communication device and the gaming machine 655 or central access controller 610.

The operator inputs the access return code to the gaming machine 655 via a user interface, for example via a keypad or touch screen. The access control module 656 grants access in accordance with the specific permissions defined in the access return code. It should be appreciated that the central access controller controls the access to the stand alone gaming machine 655 and no local operator verification is performed.

### Example 4

In this example, an operator access request is denied for the game controller 690. In this example, an operator requests access to the game controller 690 using an ID device 660, for example, by connecting the ID device to the game controller via a USB port. The access control module 695 of the game controller 690 generates an access control code using an identifier for the game controller 690 and the identifier of the ID device 660. The access control code is transmitted to the central access controller via the gaming network 640.

The central access controller looks up access permissions 630 for the game controller 690 and the operator assigned to the ID device 660. In this example the operator's access level is not high enough for access to the game controller, so access is denied. An access return code is generated indicating that access is denied. The unauthorized access attempt is also logged by the central access controller, the log can indicate the time of the request, the gaming system component subject of the access request, ID device from which the request originated, reason for the request denial and any other relevant information.

The access return code is provided to the game controller 690 by the central access controller via the gaming network 640. The access control module 695 denies access to the operator in accordance with the access return code. The game controller may output a message indicating that access is denied.

In some embodiments a reason for the denial may also be output. For example, if the operator is only authorized to access the game controller 690 during a period scheduled for routine maintenance and the access request is made after the allocated maintenance window, then the access denial message may indicate this. The operator may manually contact a back office operator to request a new maintenance window to be allocated. The back office operator may configure the access permissions 630 in the central access controller 610 accordingly to assign a new maintenance window. In another example, if an ID device is used to attempt to access a gaming system component for which the operator is not authorized, the operator's access permissions may be automatically modified to remove some or all access permissions. The level of access permission may be reduces after a number of unauthorized access attempts, or progressively reduces for each unauthorized access attempt. The unauthorized access attempt may be considered an attempted fraudulent use of the ID device, for example if an ID device is stolen, and the operator access permissions modified accordingly to reduce the risk of security breaches. In another example, if an ID device is known to be stolen a back office operator may modify the access permissions to deny all access for the stolen ID device.

It should be appreciated that embodiments of the present invention enable access to all gaming system components to be centrally configured and controlled, even for stand alone, off-line gaming system components.

Further aspects of the method will be apparent from the above description of the system. It will be appreciated that at least part of the method will be implemented electronically, for example, digitally by a processor executing program code such as in the above description of a game controller. In this respect, in the above description certain steps are described as being carried out by a processor of a gaming system, it will be appreciated that such steps will often require a number of sub-steps to be carried out for the steps to be implemented electronically, for example due to hardware or programming limitations. For example, to carry out a step such as evaluating, determining or selecting, a processor may need to compute several values and compare those values.

As indicated above, the method may be embodied in program code. The program code could be supplied in a number of ways, for example on a tangible computer readable storage medium, such as a disc or a memory device, e.g. an EEPROM, (for example, that could replace part of memory 103) or as a data signal (for example, by transmitting it from a server). Further different parts of the program code can be executed by different devices, for example in a client server relationship. Persons skilled in the art, will appreciate that program code provides a series of instructions executable by the processor.

Herein the term “processor” is used to refer generically to any device that can process game play instructions in accordance with game play rules and may include: a microprocessor, microcontroller, programmable logic device or other computational device, a general purpose computer (e.g. a PC) or a server. That is a processor may be provided by any suitable logic circuitry for receiving inputs, processing them in accordance with instructions stored in a memory and generating outputs (for example on the display). Such processors are sometimes also referred to as central processing units (CPUs). Most processors are general purpose units, however, it is also know to provide a specific purpose processor, for example, an application specific integrated circuit (ASIC) or a field programmable gate array (FPGA).

It will be understood to persons skilled in the art of the invention that many modifications may be made without departing from the spirit and scope of the invention, in particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method of authorizing access to a gaming system component, the method comprising the steps of:
receiving a request from an operator for access to a gaming system component using an identification device;
in response to the access request, the gaming system component generating and outputting an access control code, the access control code being generated based on a gaming system component identifier and an identifier of the identification device;
receiving the access control code at a computer implemented access controller whereafter the access controller, identifies from the access control code the gaming system component subject of the access request and the operator making the request based on the identification device identifier, and determines access permission based on a combination of the gaming system component and an access level assigned to the operator; and
upon access being permitted, generating an access return code; and
receiving the access return code at the gaming system component to enable operator access.

2. A method as claimed in claim 1 wherein the access return code includes login validation data and operator specific access permission data.

3. A method as claimed in claim 2 wherein the operator specific access permission data is encrypted.

4. A method as claimed in claim 1 where the access control code and the access return code are communicated via a gaming network.

5. A method as claimed in claim 1 wherein the access control code and access return code are communicated via the operator's identification device.

6. A method as claimed in claim 1 wherein access to the gaming system component is determined by the central controller looking up specific access permissions for the operator identified by their identifier device identifier and determining access permissions for the gaming system component subject of the access request.

7. A method as claimed in claim 1 wherein the gaming system component identifier is a secret key.

8. A method as claimed in claim 7 wherein the secret key of each gaming system component is stored in a database of the access controller.

9. A method as claimed in claim 1 further comprising the step of configuring operator access permissions for one or more gaming system component by updating stored access permission data of the access controller only.

10. A method as claimed in claim 1 used to access networked or stand alone gaming system component.

11. A method as claimed in claim 1 further comprising the step of providing data to the gaming system component after access is granted.

12. A gaming system comprising:
one or more gaming system components, each gaming system component including an access control module adapted to, in response to an access request made using an identification device, generate an access control code based on a gaming system component identifier and an identifier of the identification device, and allow access to the gaming system component in response to receiving an authorizing access return code;
an access controller adapted to receive the access control code and determine access permission based on a combination of the gaming system component and access level assigned to the operator of the identification device, and where access is to be permitted generate an access return code to enable the operator to access the requested gaming system component.

13. A gaming system as claimed in claim 12 wherein the access return code includes login validation data and operator specific access permission data.

14. A gaming system as claimed in claim 13 wherein the operator specific access permission data is encrypted.

15. A gaming system as claimed in claim 12 where the access control code and the access return code are communicated via a gaming network.

16. A gaming system as claimed in claim 12 wherein the access control code and access return code are communicated via the operator's identification device.

17. A gaming system as claimed in claim 12 wherein the access controller includes a database storing access permission data and access to the gaming system component is determined by the access controller looking up specific access permissions for the operator identified by their identifier device identifier and determining access permissions for the gaming system component subject of the access request.

18. A gaming system as claimed in claim 17 wherein operator access permissions are configured for one or more gaming system component by updating stored access permission data of the access controller database only.

19. A gaming system as claimed in claim 12 wherein each gaming system component stores a secret key which is used as the gaming system component identifier by the access controller.

20. A gaming system access controller comprising:
a database storing access permission data;
a communication interface adapted to receive access control codes and transmit access return codes; and
a control module adapted to, in response to receiving an access control code, generated by a gaming system component based on a identifier of an identification device used to request access to the gaming system component and an identifier of the gaming system component, looking up stored access permission data in the database to determine access permission based on a combination of the gaming system component and access level assigned for the operator of the identification device, and generating an access return code including login validation data and specific access permission data for access to the gaming system component.

21. A gaming system component including an access control module adapted to, in response to an access request made using an identification device, generate an access control code based on a gaming system component identifier and an identifier of the identification device for transmission to an access controller, and in response to receiving an authorizing access return code generated by the access controller allow operator access to the gaming system component.

22. A method as claimed in claim 1 further comprising executing computer program code for authorizing said access.

23. A method as claimed in claim 22 further comprising storing said computer program code in a tangible computer readable medium.

24. A method as claimed in claim 22 further comprising transmitting the program code in a data signal.
